(19) United States
(12) Patent Application Publication
(10) Pub. No.: US 2004/0098922 A1
(43) Pub. Date: May 27, 2004

(54) Door for vehicle

(76) Inventor: Hayami Nakagawa, Aichi (JP)

Correspondence Address: BIRCH STEWART KOLASCH & BIRCH, PO BOX 747, FALLS CHURCH, VA, 22040-0747, US

(21) Appl. No.: 10/718,810

(22) Filed: Nov. 24, 2003

(30) Foreign Application Priority Data
Nov. 26, 2002 (JP) 2002-341786

(51) Int. Cl. B60J 5/04

(52) U.S. Cl. 49/502

(57) ABSTRACT

A door for a vehicle includes an outer panel and an inner panel provided with an opening in a vehicle longitudinal-direction central portion thereof. A base plate to which at least a window regulator module is assembled is attached to the inner panel so as to wholly cover the central opening of the inner panel.

### CROSS REFERENCE TO RELATED APPLICATION

This non-provisional application incorporates by reference the subject matter of Application No. 2002-341786 filed in Japan on Nov. 26, 2002, on which a priority claim is based under 35 U.S.C. 119(a).

### BACKGROUND OF THE INVENTION

1. Field of the Invention

The present invention relates to a structure of a door in a vehicle.

2. Description of the Related Art

As a structure of a door for a vehicle, one disclosed in Japanese Patent No. 2,927,311 is conventionally known.

In this technique, a door is constructed by combining an outer module with an elevating module. However, since a large opening is formed in an inner panel of the outer module, the sound insulation of the door itself is deteriorated. In addition, it is necessary to attach a waterproofing film to the door in order to prevent rainwater, which has entered in the door, from leaking to the vehicle compartment side. For this reason, there is a problem in that the efficiency in the door assembling operation is lowered.

### SUMMARY OF THE INVENTION

It is an object of the present invention to improve the sound insulation of the door itself while enhancing the accuracy of attaching a door glass in a vehicle.

According to the present invention, there is provided a door for a vehicle including: an outer panel; a substantially U-shaped inner panel whose vehicle longitudinal-direction edges and lower edge are connected to the outer panel, the inner panel having a central opening; and a base plate which is disposed between the outer and inner panels and wholly covers the central opening and to which a door glass and an elevating regulator are assembled.

Accordingly, since the base plate is disposed between the outer panel and the inner panel of the door, the door glass and the elevating regulator (window regulator) are integrally incorporated between both panels. Therefore, the attaching accuracy of the door glass is enhanced, and the door assembling operation is facilitated. Also, since the base plate wholly covers the central opening of the inner panel, it becomes possible to reliably improve the sound insulation of the door itself.

### BRIEF DESCRIPTION OF THE DRAWINGS

FIG. 1 is an exploded perspective view of an embodiment of the invention; and

FIG. 2 is a schematic cross-sectional view taken along line II-II in FIG. 1.

### DETAILED DESCRIPTION OF THE PREFERRED EMBODIMENT

An embodiment of the present invention will be described with reference to the accompanying drawings.

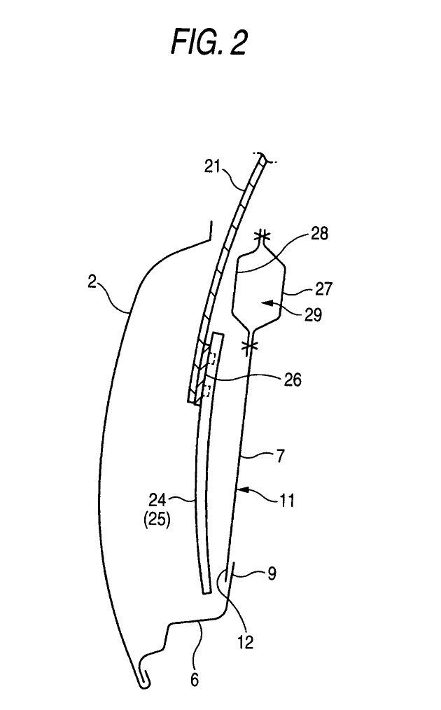

A door 1 in a vehicle includes an outer panel 2, an inner panel 6, a base plate 7, and a trim 8. Vehicle longitudinal-direction edges (a front edge and a rear edge) 3 and 4 and lower edge 5 of the inner panel 6 are respectively connected to the outer panel 2. Further, The inner panel 6 has a central opening of a notched shape that gradually becomes narrower from an upper edge toward the lower side thereof. Namely, the inner panel 6 has a substantially U-shaped configuration in a side view. The base plate 7 is disposed between both panels 2 and 6. The door trim 8 is attached to the vehicle compartment inner side of the inner panel 6. An inner edge 9 of the inner panel 6 and a peripheral edge 10 extending from each of vehicle front and rear sides to a lower side of the base plate 7 are joined by screws or the like. Consequently, the base plate 7 wholly covers a central opening 11 of the inner panel 6 from the vehicle compartment outer side. At this time, as shown in FIG. 2, a lower edge 12 of the base plate 7 is disposed in contact with the vehicle outer side of the inner edge 9 of the inner panel.

A window regulator 22 for a door glass 21, i.e., a drive motor 23 and guide rails 24 and 25, which are disposed in such a manner as to be spaced apart from each other in the longitudinal direction of the vehicle, are fixed to the base plate 7. A supporting plate 26 fixed to a lower portion of the door glass 21 is arranged to be lifted or lowered along both guide rails 24 and 25 by means of unillustrated rollers or sliders to allow the door glass 21 to open or close the door window.

A belt line reinforcement 28 is integrally connected to an upper edge 27 of the base plate 7 to form a closed section 29. A delta plate 30 is integrally formed on a vehicle front side of the base plate 7. The front and rear end portions of the belt line reinforcement 28 are fixed to the base plate by bolts, welding, etc.

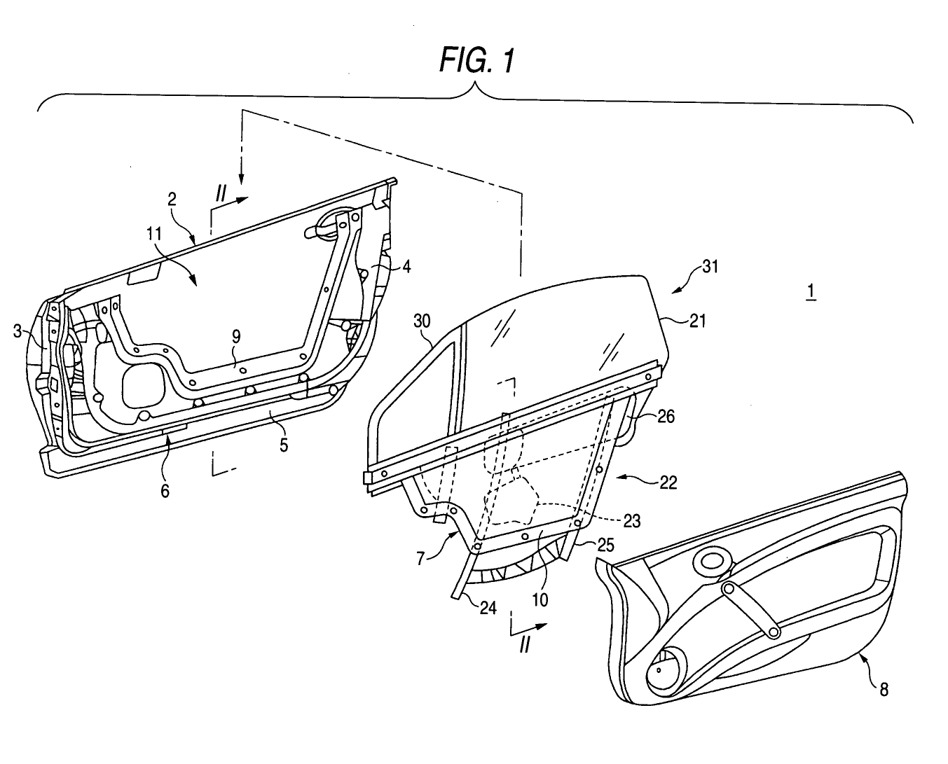

In the door 1, the window regulator 22 including the drive motor 23 and the guide rails 24 and 25 is fixed to the base plate 7, and the door glass 21 is assembled to the base plate 7 through the guide rails 24 and 25 and the supporting plate 26, thereby integrally constituting the entire unit as a door glass module 31. In addition, the inner panel 6 connected to the outer panel 2 has the relatively large central opening 11, and this central opening 11 has such a notched shape that its upper side is wide and it gradually becomes narrower toward the lower side. Therefore, when inserting the door glass module 31 between the outer panel 2 and the inner panel 6, the lifting height of the door glass module 31 can be made relatively small by lifting the door glass module 31 to a position where the vehicle longitudinal-direction width of the base plate 7 becomes smaller than the vehicle longitudinal-direction width of the central opening. For this reason, it is possible to shorten the vertical stroke of a carrier such as a robot arm with respect to the door glass module 31 to thereby reduce the working space and shorten the operating time. Hence, there is an advantage in that the assembling operation of the door 1 becomes simple. As the direction of insertion of the door glass module, a direction from the vehicle compartment inner side or a direction from above as shown by the chain line arrow in FIG. 1 is conceivable.

The base plate 7 has substantially the same shape with that of the central opening 11 of the inner panel 6. The peripheral portion of the base plate 7 is fixed to the inner edge 9 of the inner panel 6.

Since the door glass 21 and the window regulator module 22 are assembled in advance to the base plate 7 so as to be integrated as the door glass module 31, it is possible to easily enhance the assembling accuracy of such as the door glass 21, the drive motor 23, and the guide rails 24 and 25 in the door glass module 31. Further, since this door glass module 31 is connected to the inner panel 6, it is also possible to easily enhance the assembling accuracy of the door glass 21 in the door 1. From these reasons, pre-positioning operation of the door glass 21 in the vehicle assembly line becomes unnecessary, thereby making it possible to attain a substantial reduction in the number of steps of assembly operation.

In addition, since the substantially U-shaped inner panel 6 has the relatively large central opening 11, the operation of assembling various accessories between the outer panel 2 and the inner panel 6 is relatively easy. Since the base plate 7 of the door glass module 31 wholly covers the central opening 11 of the inner panel 6, the sound insulation of the door 1 itself is ensured, so that the vehicle compartment becomes excellently comfortable.

Furthermore, since the lower edge 12 of the base plate 7 is disposed on the vehicle outer side of the inner edge 9 of the inner panel, even if rainwater or the like which has entered the interior of the door 1 flows down along a vehicle outer side surface of the base plate 7, it is possible to easily prevent the rainwater or the like from flowing to the vehicle compartment inner surface of the inner panel 6, i.e., to the vehicle compartment inner side. Accordingly, it becomes unnecessary to attach a waterproofing film to the door 1 as in the conventional manner, so that the assembling operation of the door 1 can be improved in this aspect as well.

In addition, since the base plate 7 is attached to the inner panel 6 in a state in which the belt line reinforcement 28 is fixed in advance to the base plate 7, it is possible to accomplish the insertion of the module with the window 21 fixed to the base plate between the outer panel and the inner panel 6 while maintaining to a high degree the rigidity of the inner panel 6 whose upper edge is notched wide.

Although in the above embodiment, the door glass module 31 is inserted between the outer panel 2 and the inner panel 6, the invention is not limited to the embodiment, and the base plate 7 of the door glass module 31 may be attached to the inner panel 6 from the vehicle compartment inner side of the inner panel 6 so as to cover the central opening. In this case as well, the advantages in the reduction of the number of steps of assembly operation and the improvement of the sound insulation of the door 1 itself can be obtained.

What is claimed is:

1. A door for a vehicle comprising:
an outer panel;
an inner panel whose vehicle longitudinal-direction edges and lower edge are connected to the outer panel and whose vehicle longitudinal-direction central portion is open to form a central opening; and
a base plate to which at least a window regulator module is assembled and which is attached to the inner panel so as to wholly cover the central opening of the inner panel.

2. The door for a vehicle according to claim 1, wherein the window regulator module and the door glass are pre-assembled to the base plate, so pre-assembled the base plate is attached to the inner panel.

3. The door for a vehicle according to claim 2, further comprising a belt line reinforcement for improving the rigidity of the inner panel by being joined to an upper edge of the inner panel, the belt line reinforcement fixed in advance to the base plate.

4. The door for a vehicle according to claim 1, wherein the base plate is attached to the inner panel so as to cover the central opening from a vehicle compartment inner side of the inner panel.

5. The door for a vehicle according to claim 1, wherein the base plate is attached to the inner panel so as to cover the central opening from a vehicle compartment outer side of the inner panel.

6. The door for a vehicle according to claim 5, wherein the central opening has a notched shape which gradually becomes narrower from an upper edge toward a lower side of the inner panel.

7. The door for a vehicle according to claim 1, wherein the base plate has substantially the same shape with that of the central opening of the inner panel.

8. A door for a vehicle which is assembled by the steps of:
connecting an outer panel and an inner panel having a central opening of a notched shape that gradually becomes narrower from an upper edge toward a lower side thereof, at vehicle longitudinal-direction edges and lower edges of the outer panel and the inner panel;
assembling at least a window regulator module to a base plate of a shape in which the width gradually becomes narrower from an upper edge toward a lower side thereof so as to cover the central opening;
lifting the base plate to a position where the vehicle longitudinal-direction width of the central opening becomes wider than the vehicle longitudinal-direction width of the base plate, and inserting the base plate between the inner panel and the outer panel; and
covering the central opening with the base plate and joining the base plate and the inner panel.
